(19) United States
(12) Patent Application Publication
(10) Pub. No.: US 2003/0218282 A1
(43) Pub. Date: Nov. 27, 2003

(54) Equilibrium adjusting device for a seat suspension

(76) Inventor: Yutaka Sakamoto, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 10/421,732

(22) Filed: Apr. 24, 2003

(30) Foreign Application Priority Data
Apr. 26, 2002 (JP) 2002-126530

(51) Int. Cl. F16F 1/00

(52) U.S. Cl. 267/131

(57) ABSTRACT

A seat suspension includes a lower frame mounted on a floor of an automotive body, an upper frame vertically movably mounted on the lower frame, a magnetic spring for elastically supporting the upper frame, and an equilibrium adjusting device for adjusting the position of equilibrium of the upper frame relative to the lower frame. The equilibrium adjusting device includes a torsion bar for elastically supporting the upper frame and a link mechanism connected to the torsion bar. The upper frame is moved vertically by rotating the torsion bar via the link mechanism so that the position of equilibrium of the upper frame relative to the lower frame may be adjusted according to a load applied to the upper frame.

### BACKGROUND OF THE INVENTION

1. Field of the Invention

The present invention relates generally to an automotive seat suspension employing a magnetic spring therein and, in particular but not exclusively, to an equilibrium adjusting device for adjusting the position of equilibrium of an upper frame relative to a lower frame according to a load applied to the upper frame.

2. Description of the Related Art

The applicant of this invention or others have hitherto proposed a variety of automotive seat suspensions employing a magnetic spring therein, but they have no mechanism for adjusting the position of equilibrium according to a load (weight of a seat occupant).

### SUMMARY OF THE INVENTION

The present invention has been developed to overcome the above-described disadvantages.

It is accordingly an objective of the present invention to provide a comparatively inexpensive and reliable equilibrium adjusting device capable of adjusting the position of equilibrium with a simplified construction.

In accomplishing the above and other objectives, the equilibrium adjusting device according to the present invention includes a torsion bar for elastically supporting an upper frame relative to a lower frame and a link mechanism connected to the torsion bar, wherein the upper frame is moved vertically by rotating the torsion bar via the link mechanism so that the position of equilibrium of the upper frame relative to the lower frame is adjusted according to a load applied to the upper frame.

In a seat suspension having a magnetic spring for elastically supporting the upper frame relative to the lower frame, the equilibrium adjusting device of the above-described construction can adjust the position of equilibrium with a simplified construction Also, this equilibrium adjusting device can be manufactured at a low cost.

Conveniently, the equilibrium adjusting device includes an adjusting nut connected to the link mechanism, an adjusting screw held in mesh with the adjusting nut, a driving source connected to the adjusting screw, and a position detector for detecting a vertical position of the upper frame relative to the lower frame. The adjusting screw is driven by the driving source in response to an output from the position detector, thereby adjusting the position of equilibrium of the upper frame relative to the lower frame.

It is preferred that the position of equilibrium of the upper frame relative to the lower frame be adjusted only when a parking brake is used or a shift lever is in a parking position.

Advantageously, the equilibrium adjusting device includes a manual operating member attached to the adjusting screw, wherein the position of equilibrium of the upper frame relative to the lower frame can be adjusted by manipulating the manual operating member.

### BRIEF DESCRIPTION OF THE DRAWINGS

The above and other objectives and features of the present invention will become more apparent from the following description of a preferred embodiment thereof with reference to the accompanying drawings, throughout which like parts are designated by like reference numerals, and wherein:

FIG. 1 is a perspective view of a seat suspension having an equilibrium adjusting device according to the present invention;

FIG. 2 is another perspective view of the seat suspension of FIG. 1;

FIG. 3 is a top plan view of the seat suspension of FIG. 1;

FIG. 4 is a left side view of the seat suspension of FIG. 1;

FIG. 5 is a right side view of the seat suspension of FIG. 1;

FIG. 6 is an exploded perspective view of the seat suspension of FIG. 1;

FIG. 7 is a control circuit diagram for the equilibrium adjusting device;

FIG. 8 is a motor drive circuit diagram for the equilibrium adjusting device; and

FIG. 9 is a schematic diagram explanatory of the equilibrium adjusting operation of the equilibrium adjusting device.

### DETAILED DESCRIPTION OF THE PREFERRED EMBODIMENTS

This application is based on an application No. 2002-126530 filed Apr. 26, 2002 in Japan, the content of which is herein expressly incorporated by reference in its entirety.

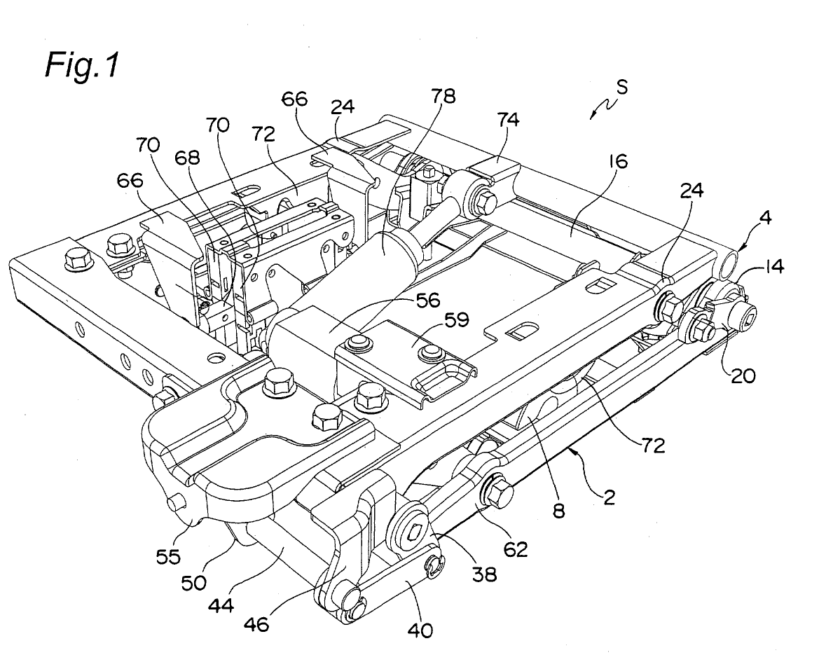

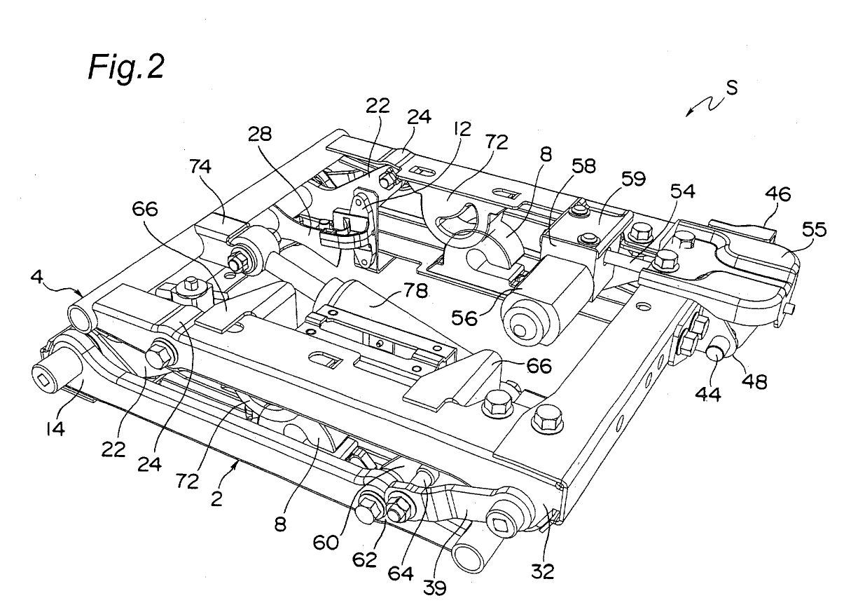

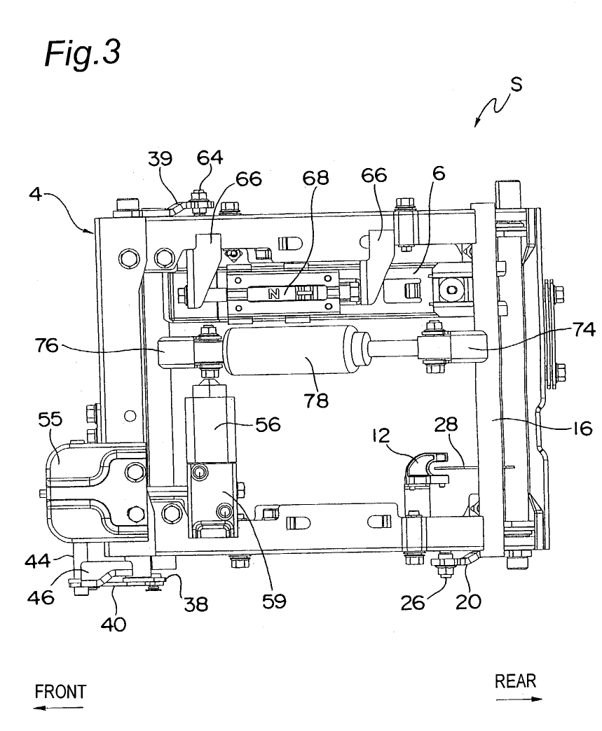

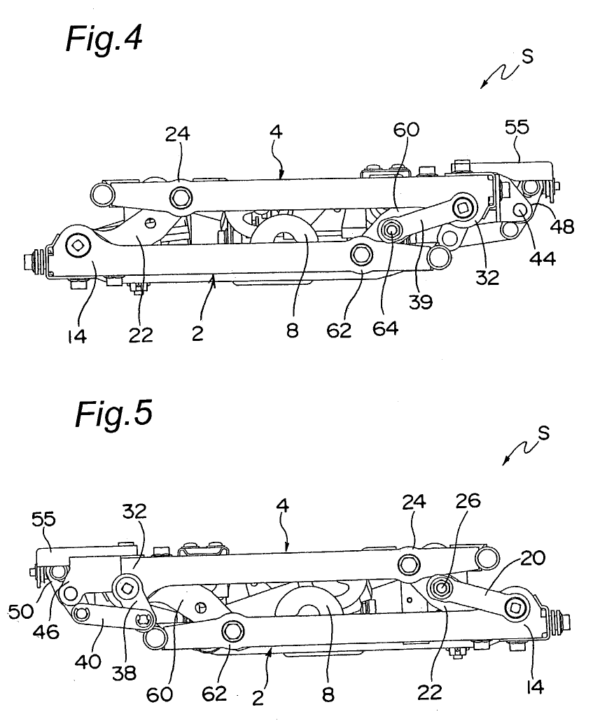

Referring now to the drawings, there is shown in FIGS. 1 to 6 an automotive seat suspension S provided with an equilibrium adjusting device according to the present invention. The seat suspension S includes a generally rectangular lower frame 2 mounted on a floor of an automotive body and a generally rectangular upper frame 4 vertically movably mounted on the lower frame 2. An automotive seat (not shown) is placed on and rigidly secured to the upper frame 4.

The lower frame 2 has front and rear portions to which opposite ends of a longitudinally extending magnet unit holder 6 are joined respectively, and a stationary magnet assembly of a magnet unit is secured to the magnet unit holder 6. The lower frame 2 also has opposite side portions, to each of which a cushioning member 8 made of, for example, rubber is secured, and a sensor unit 12 is mounted on one (for example, left side portion) of the side portions of the lower frame 2 via a bracket 10.

The lower frame 2 further has two bearings 14 formed therewith on the rear side of the opposite side portions thereof, and opposite ends of a cylindrical rear suspension link 16 are rotatably received in the two bearings 14, respectively. A rear torsion bar 18 is accommodated in the rear suspension link 16 so as extend therethrough. The rear torsion bar 18 has one end connected to one end of a lever 20 and the other end secured to the lower frame 2.

Opposite ends of the rear suspension link 16 are respectively connected to ends of two arms 22 extending parallel to each other, the other ends of which are respectively rotatably received in bearings 24 formed with the upper frame 4 on the rear side of the opposite side portions thereof. One of the arms 22 has a pin 26 secured to an intermediate portion thereof, to which the other end of the lever 20 is connected. A positioning plate 28 extending parallel to the arms 22 is secured at its proximal end to the rear suspension link 16 and is opposed at its distal end to the sensor unit 12.

The sensor unit 12 includes a non-contact position sensor that outputs an ON or OFF signal by detecting whether it overlaps with the positioning plate 28.

On the other hand, the upper frame 4 has two bearings 32 formed therewith on the front side of opposite side portions thereof, and opposite ends of a cylindrical front suspension link 34 are rotatably received in the two bearings 32, respectively. A front torsion bar 36 is accommodated in the front suspension link 34 so as extend therethrough. The front torsion bar 36 has opposite ends connected to one end of a lever 38 and to one end of a lever 39, respectively.

The other end of the lever 38 is pivotally connected to one end of a lever 40, the other end of which is pivotally connected to one end of a lever 42. The other end of the lever 42 is secured to one end of a rotary shaft 44, opposite ends of which are respectively rotatably connected to brackets 46, 48 secured to a front portion of the upper frame 4. Two levers 50 extending parallel to each other are secured at one end thereof to an intermediate portion of the rotary shaft 44, and the other ends of the two levers 50 are pivotally connected to opposite ends of an adjusting nut 52, respectively. The adjusting nut 52 is held in mesh with an adjusting screw 54. The adjusting screw 54 is rotatably connected at its screw side end to a bracket 55 threaded to the upper frame 4 and is connected at its other end to a gear box 58 juxtaposed with an electric motor 56 so that the adjusting screw may be driven by the electric motor 56 via the gear box 58. The gear box 58 is secured to a bracket 59 threaded to the upper frame 4.

Two arms 60 extending parallel to each other are secured at one end thereof to opposite ends of the front suspension link 34, respectively, and the other ends of the two arms 60 are rotatably received in bearings 62 formed with the lower frame 2 on the front side of opposite side portions thereof. One of the two arms 60 has a pin 64 secured to an intermediate portion thereof, to which the other end of the lever 39 is pivotally connected.

A movable magnet assembly 68 is held at opposite ends thereof by two spaced apart brackets 66 secured to the upper frame 4 on one side thereof. The movable magnet assembly 68 is vertically movably interposed between two opposed stationary magnet assemblies 70 that are held by the magnet unit holder 6 secured to the lower frame 2 as described above. The magnet unit is comprised of the movable magnet assembly 68 and the stationary magnet assemblies 70.

A cushioning member 72 made of, for example, rubber is secured to each of the opposite side portions of the upper frame 4. A damper 78 is connected at opposite ends thereof to a bracket 74 secured to a rear portion of the upper frame 4 and to a bracket 76 secured to a front portion of the lower frame 2, respectively.

The seat suspension S of the above-described construction operates as follows.

When a load (weight of a seat occupant) is applied to a seat (not shown) secured to the upper frame 4, both the arms 60 connected to the front suspension link 34 and the arms 22 connected to the rear suspension link 16 pivot. As a result, the upper frame 4 sinks (moves downwards towards the lower frame 2) according to the magnitude of the load, and the equilibrium adjustment is carried out by the equilibrium adjusting device according to the present invention.

The load at the position of equilibrium is supported by an elastic force of a magnetic spring constituted by the movable magnet assembly 68 and the stationary magnet assemblies 70 in the magnet unit and by elastic forces created by the torsion of the rear torsion bar 18 within the rear suspension link 16 and that of the front torsion bar 36 within the front suspension link 34.

When vibration is inputted from outside, the upper frame 4 moves vertically relative to the lower frame 2. During the vertical movement of the upper frame 4, the elastic force of the magnet unit and the elastic forces of the torsion bars 18, 36 vary according to the distance between the upper and lower frames 4,2, thus absorbing the vibration.

Furthermore, when an impact force exceeding the elastic force of the magnet unit and the elastic forces of the torsion bars 18, 36 is inputted, the damper 78 and the cushioning members 8, 72 act to absorb the impact force.

The equilibrium adjusting device according to the present invention is discussed hereinafter.

The equilibrium adjusting device includes the sensor unit 12 employed as a position detector for detecting the amount of shift from the position of equilibrium, the electric motor 56 employed as a driving source, the adjusting screw 54 connected to the gear box 58, the adjusting nut 52 held in mesh with the adjusting screw 54, and a link mechanism from the two levers 50, to which the adjusting nut 52 is mounted, to the lever 39 connected to one of the arms 60.

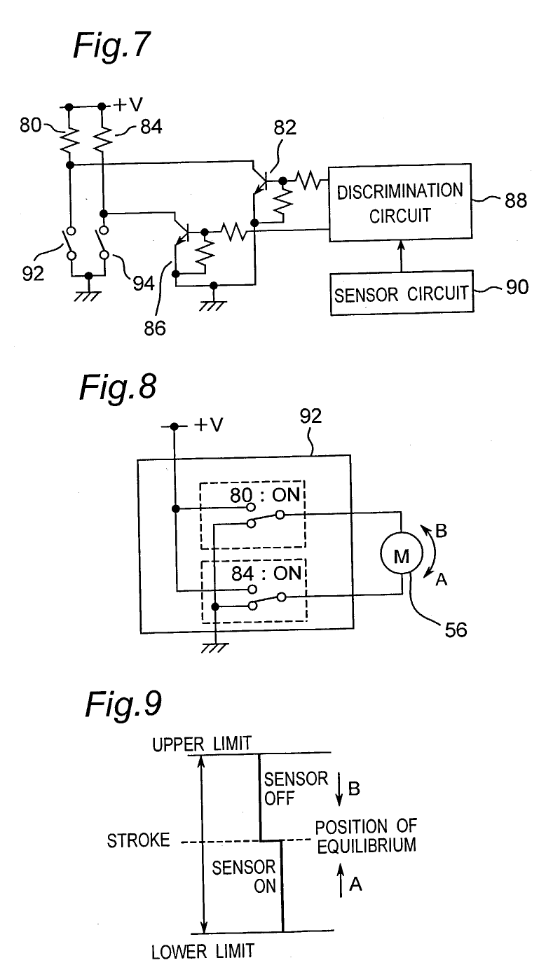

FIG. 7 depicts a control circuit for the equilibrium adjusting device according to the present invention. In the control circuit as shown therein, a combination of a resistor 80 and a transistor 82 connected in series and a combination of a resistor 84 and a resistor 86 similarly connected in series are connected in parallel, and the transistors 82, 86 are connected to a discrimination circuit 88, which is in turn connected to a sensor circuit 90. The resistors 80, 84 are connected to manual switches 92, 94 in series, respectively.

The sensor circuit 90 includes a non-contact position sensor as described above, but a limit switch or the like can be used in place of the non-contact position sensor.

FIG. 8 depicts a motor drive circuit in which the electric motor 56 is connected to a motor driver 92 including, for example, relays.

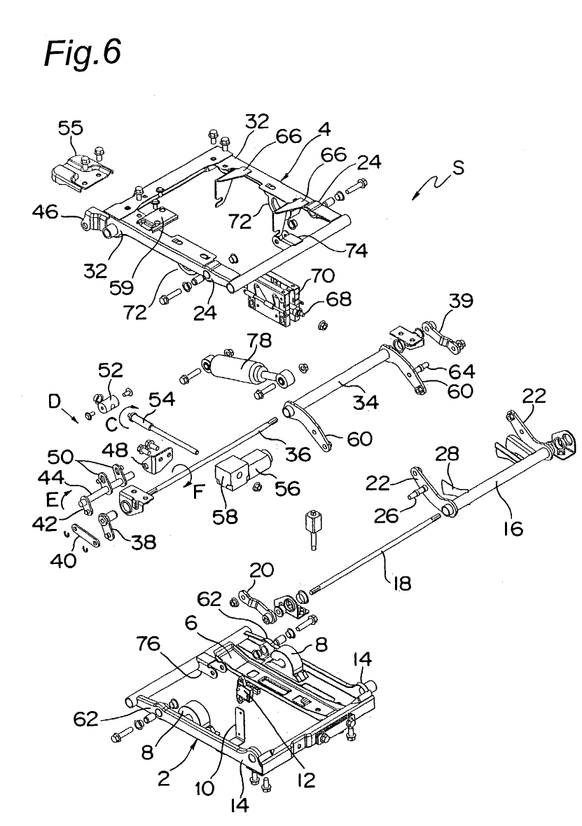

The operation for controlling the direction of rotation of the electric motor 56 is explained hereinafter with reference to FIGS. 6 to 9.

When the load is heavier than a set value, the upper frame 4 sinks below the position of equilibrium, and the positioning plate 28 moves away from the sensor unit 12. As a result, an ON signal is inputted from the sensor circuit 90 to the discrimination circuit 88, and the transistor 86 turns on to cause electricity to flow through the resistor 84, resulting in the electric motor 56 rotating in the direction shown by an arrow A. The rotation of the electric motor 56 in the direction of the arrow A causes a driving force of the electric motor 56 to be transmitted to the adjusting screw 54 via the gear box 58, and the adjusting screw 54 is rotated in the direction shown by an arrow C, which in turn causes the adjusting nut 52 in mesh with the adjusting screw 54 to slide in the direction shown by an arrow D. Accordingly, the rotary shaft 44 rotates in the direction shown by an arrow E and, hence, the front torsion bar 36 rotates in the direction shown by an arrow F via the levers 42, 40, 38, and the lever 39 connected to the end of the front torsion bar 36 also rotates in the same direction as the front torsion bar 36. As a result, the front suspension link 34 moves upwards to lift the upper frame 4.

When the upper frame 4 is lifted and reaches the position of equilibrium, the sensor unit 12 overlaps with the positioning plate 28 again, and the input of the ON signal from the sensor circuit 90 to the discrimination circuit 88 is ceased to cause the electric motor 56 to come to a stop. In this way, the equilibrium adjustment is completed.

In contrast, when the load is lighter than the set value, the upper frame 4 moves upwards above the position of equilibrium. An OFF signal is then inputted from the sensor circuit 90 to the discrimination circuit 88, and the transistor 82 turns on to cause electricity to flow through the resistor 80, resulting in the electric motor 56 rotating in the direction shown by an arrow B. The rotation of the electric motor 56 in the direction of the arrow B causes the adjusting screw 54 to rotate in the direction counter to the arrow C and the adjusting nut 52 in mesh with the adjusting screw 54 to slide in the direction counter to the arrow D. As a result, the link mechanism operates in the manner reverse to the above-described manner, and the upper frame 4 is moved downwards by the front suspension link 34 until it reaches the position of equilibrium.

It is to be noted here that the use of a comparator or the like having a hysteresis loop for the discrimination circuit 88 can avoid the hunting of the position of equilibrium in response to the ON/OFF operations of the sensor unit 12. Any appropriate software can also be used in place of the comparator.

It is also to be noted that as shown in FIG. 7, the equilibrium adjustment by the electric motor 56 can be performed using the manual switches 92, 94.

It is further to be noted that the transistors 82, 86 are set so as to turn on only when the parking brake is used or the shift lever is in the parking position.

Although in the above-described embodiment the full automatic operation has been discussed wherein the equilibrium adjustment is performed automatically by an act of merely sitting on the seat, the semi-automatic operation is also possible wherein the upper frame 4 is set at the position of equilibrium by depressing a limit switch provided in place of the sensor unit 12.

Furthermore, upon removal of the sensor unit 12, electric motor 56, gear box 58 and the like, a dial employed as a manual operating member may be attached to the adjusting screw 54 with an indicator attached at an appropriate position. By so doing, the equilibrium adjustment can be manually performed by manipulating the dial while confirming the indicator.

Although the present invention has been fully described by way of examples with reference to the accompanying drawings, it is to be noted here that various changes and modifications will be apparent to those skilled in the art. Therefore, unless such changes and modifications otherwise depart from the spirit and scope of the present invention, they should be construed as being included therein.

What is claimed is:

1. An equilibrium adjusting device for use in a seat suspension having a lower frame mounted on a floor of an automotive body, an upper frame vertically movably mounted on the lower frame, and a magnetic spring for elastically supporting the upper frame relative to the lower frame, said equilibrium adjusting device comprising:
a torsion bar for elastically supporting the upper frame relative to the lower frame; and
a link mechanism connected to the torsion bar;
wherein the upper frame is moved vertically by rotating the torsion bar via the link mechanism so that a position of equilibrium of the upper frame relative to the lower frame is adjusted according to a load applied to the upper frame.

2. The equilibrium adjusting device according to claim 1, further comprising an adjusting nut connected to the link mechanism, an adjusting screw held in mesh with the adjusting nut, a driving source connected to the adjusting screw, and a position detector for detecting a vertical position of the upper frame relative to the lower frame, wherein the adjusting screw is driven by the driving source in response to an output from the position detector, thereby adjusting the position of equilibrium of the upper frame relative to the lower frame.

3. The equilibrium adjusting device according to claim 2, wherein the position of equilibrium of the upper frame relative to the lower frame can be adjusted only when a parking brake is used or a shift lever is in a parking position.

4. The equilibrium adjusting device according to claim 1, further comprising an adjusting nut connected to the link mechanism, an adjusting screw held in mesh with the adjusting nut, and a manual operating member attached to the adjusting screw, wherein the position of equilibrium of the upper frame relative to the lower frame is adjusted by manipulating the manual operating member.
